(19) United States
(12) Patent Application Publication
(10) Pub. No.: US 2024/0382954 A1
(43) Pub. Date: Nov. 21, 2024

(54) MICROFLUIDIC DEVICE FOR REACTING A MIXTURE CONTAINED WITHIN A LAMINAR CO-FLOWING CONCENTRIC BUFFER

(71) Applicant: THE TRUSTEES OF COLUMBIA UNIVERSITY IN THE CITY OF NEW YORK, New York, NY (US)

(72) Inventors: Xiangsong FENG, New York, NY (US); Joachim FRANK, New York, NY (US)

(73) Assignee: THE TRUSTEES OF COLUMBIA UNIVERSITY IN THE CITY OF NEW YORK, New York, NY (US)

(21) Appl. No.: 18/785,765

(22) Filed: Jul. 26, 2024

Related U.S. Application Data
(63) Continuation of application No. PCT/US23/11681, filed on Jan. 27, 2023.
(60) Provisional application No. 63/303,737, filed on Jan. 27, 2022.

(51) Int. Cl. B01L 3/00

(52) U.S. Cl. CPC B01L 3/50273; B01L 2200/0605; B01L 2200/0636; B01L 2200/16

(57) ABSTRACT

The present subject matter relates to devices and techniques for reducing the parabolic velocity profile. The disclosed device can include a coflow generator configured to receive a buffer solution and a mixture of at least two components to form a coflow pattern in a tubing, and a coflow separator configured to seperate the buffer solution from the reaction mixture. The coflow generator and the coflow separator can be coupled through the tubing. The tubing can be configured to receive the mixture and the buffer solution from the coflow generator and have the mixture bounded by the buffer solution without contacting a wall of the tubing.

### CROSS-REFERENCE TO RELATED APPLICATION

This application is a continuation of International Patent Application No. PCT/US2023/011681, which was filed on Jan. 27, 2023, which claims priority to U.S. Provisional Patent Application No. 63/303,737, which was filed on Jan. 27, 2022, the entire contents of which are incorporated by reference herein.

### GRANT INFORMATION

This invention was made with government support under grant numbers GM055440, GM029169, and GM139453 awarded by the National Institutes of Health. The government has certain rights in the invention.

### BACKGROUND

Certain chemical processes require the use of continuous-flow or stopped-flow devices that mix two components and let them react while the mixture flows in a channel. In such devices, the channel volume at a given flow rate defines the total reaction time.

In conditions of laminar flow, the wall of the channel creates drag, causing the highest velocity in the center while the lowest at the wall. As a consequence, there is a broadening of the radial velocity distribution that can increase with the length of the channel traveled by the mixture. In microfluidic devices, where this effect is very large, the velocity profile is parabolic. The broadening of the radial velocity distribution increases with increasing channel length and can prevent accurate control of time in time-resolved reactions.

Therefore, there is a need for improved devices and techniques for reducing the dispersive effect caused by the parabolic velocity profile.

### SUMMARY

The disclosed subject matter provides devices and techniques for the parabolic velocity profile.

An example device can include a coflow generator and a coflow separator. The coflow generator can be configured to provide a buffer solution and a mixture of at least two components to form a coflow pattern in the tubing. The coflow separator can be configured to separate the buffer solution from the reaction mixture. The coflow generator and the coflow separator can be coupled through the tubing. The tubing can be configured to receive the reaction mixture and the buffer solution from the coflow generator, and thus the flow of the reaction mixture can be bounded by the buffer solution without contacting the wall of the tubing.

In certain embodiments, the coflow generator can be configured to make the buffer solution flow adjacent to the wall of the tubing. In non-limiting embodiments, the mixture and the buffer solution can flow in a laminar state in the tubing, by controlling the flowrate of the reaction mixture or the bugger solution.

In certain embodiments, the ratio between a flow rate of the buffer solution and the flow rate of the mixture ranges from about 1:1 to about 10:1. The flow rate of the buffer solution ranges from 3 μL/s to about 60 μL/s, and the flow rate of the mixture ranges from about 3 μL/s to about 6 μL/s. In non-limiting embodiments, the device can be configured to complete the reaction of the mixture in a predetermined time. The predetermined time can be less than 1000 ms.

In certain embodiments, the tubing can include a capillary tubing, a three-dimensional (3D)-printed tubing, a polyether ether ketone (PEEK) tubing, a 3D IP-S tubing, or a 3D IP-Q tubing. In some embodiments, the coflow separator can include an outlet for the release of the buffer solution.

In certain embodiments, the device can further include a micro sprayer configured to generate droplets of the mixture. The micro sprayer can be coupled to the flow separator and can include a gas inlet for providing gas pressure. In non-limiting embodiments, the tubing can be aligned and centered in a middle of the coflow separator and the micro sprayer.

In certain embodiments, the buffer solution can be guided to be on the periphery of the reaction channel and concentric to the reaction mixture. In non-limiting embodiments, the device can be a chip assembly.

The disclosed subject matter provides methods for reducing the parabolic velocity profile. An example method can include providing a buffer solution, providing a mixture of at least two components, flowing the buffer solution adjacent to an inner wall of a tubing, flowing the mixture bounded by the buffer solution without contacting the inner wall of the tubing, and purging the buffer solution at the end of the reaction channel.

In certain embodiments, the method can further include adjusting the temperature of the buffer solution or the mixture.

In certain embodiments, the method can further include adjusting the flow rate of the buffer solution, the mixture, or a combination thereof. In non-limiting embodiments, the method can further include adjusting a width of the buffer solution in the tubing to absorb the steepest part of a parabolic velocity distribution of the mixture. The width is the distance from the inner wall of the tubing to a boundary between the buffer solution and the mixture. The coflow generator and the coflow separator can be produced by a three-dimensional printer.

In certain embodiments, the method can further include generating a droplet of the mixture at a predetermined gas pressure.

The disclosed subject matter will be further described below.

### BRIEF DESCRIPTION OF THE DRAWINGS

FIG. 1 provides a diagram showing an example velocity profile in a cylindric capillary bounded by walls in accordance with the disclosed subject matter.

FIG. 2 provides a diagram showing an example co-flow design in accordance with the disclosed subject matter.

FIG. 3 provides an image and a graph showing an example mass fraction of the mixture in accordance with the disclosed subject matter.

FIG. 4 provides graphs showing an example reaction time distribution in accordance with the disclosed subject matter.

FIG. 5 provides an image showing an example device with the co-flow design in accordance with the disclosed subject matter.

FIG. 6 provides a graph showing an example geometric model for the coflow generator.

FIG. 7 provides a graph showing an example geometric model for the coflow separator.

FIG. 8 provides a graph showing an example velocity profile developed in accordance with the disclosed subject matter.

FIG. 9 provides images showing example designs of a co-flow device in accordance with the disclosed subject matter.

FIG. 10 provides images showing an example co-flowing chip assembly in accordance with the disclosed subject matter.

FIG. 11 provides a diagram showing example volumetric flowrates in accordance with the disclosed subject matter.

FIG. 12 provides a diagram showing example volumetric flowrates in accordance with the disclosed subject matter.

FIG. 13 provides a graph showing an example relationship between reaction time and concentrations of 70S ribosomes in accordance with the disclosed subject matter.

FIG. 14 provides a diagram showing example volumetric flowrates in accordance with the disclosed subject matter.

It is to be understood that both the foregoing general description and the following detailed description are exemplary and are intended to provide further explanation of the disclosed subject matter.

### DETAILED DESCRIPTION

The disclosed subject matter provides devices and techniques for narrowing the reaction time dispersion. The disclosed devices and techniques can be used for various applications, including but not limited to time-resolved cryo-Electron Microscopy (cryo-EM). The disclosed microfluidic device can rapidly mix a plurality of components (e.g., solutions containing biological molecules), cause the reaction of the components in a continuous flow, and spray the resulting reaction product onto a grid. By cutting out the center of the parabolic velocity distribution and thereby reducing the reaction time range, the microfluidic device allows achieving a more precise definition of various states of the reactants (e.g., for determination of kinetics), and the sharpened reaction time range in turn facilitates the capturing of high-resolution 3D images of short-lived intermediates requiring an accurate time stamp for each molecule imaged.

Unless otherwise defined, all technical and scientific terms used herein have the same meaning as commonly understood by one of ordinary skill in the art. In case of conflict, the present document, including definitions, will control.

As used herein, the use of the word “a” or “an” when used in conjunction with the term “comprising” in the claims and/or the specification can mean “one,” but it is also consistent with the meaning of “one or more,” “at least one,” and “one or more than one.” Still further, the terms “having,” “including,” “containing,” and “comprising” are interchangeable, and one of the skills in the art is cognizant that these terms are open-ended terms.

As used herein, the term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, up to 10%, up to 5%, and up to 1% of a given value. Alternatively, e.g., with respect to biological systems or processes, the term can mean within an order of magnitude, within 5-fold, and within 2-fold, of a value.

The terms “comprise(s),” “include(s),” “have,” “having,” “has,” “can,” “contain(s),” and variants thereof, as used herein, are intended to be open-ended transitional phrases, terms, or words that do not preclude additional acts or structures. The singular forms “a,” “an,” and “the” include plural references unless the context clearly dictates otherwise. The present disclosure also contemplates other embodiments “comprising,” “consisting of,” and “consisting essentially of,” the embodiments or elements presented herein, whether explicitly set forth or not.

The term “coupled,” as used herein, refers to the connection of a device component to another device component by methods known in the art. For example, each of the disclosed components can be coupled through a wire, a tube, a capillary tube, or any means known in the art. The term “coupled,” as used herein, can include direct contact (e.g., mechanical contact) or indirect coupling.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 as well as all intervening decimal values between the aforementioned integers such as, for example, 1.1, 1.2, 1.3, 1.4, 1.5, 1.6, 1.7, 1.8, and 1.9. Ranges disclosed herein, for example, “between about X and about Y” are, unless specified otherwise, inclusive of range limits about X and about Y as well as X and Y. With respect to sub-ranges, “nested sub-ranges” that extend from either endpoint of the range are specifically contemplated. For example, a nested sub-range of an exemplary range of 1 to 50 can include 1 to 10, 1 to 20, 1 to 30, and 1 to 40 in one direction, or 50 to 40, 50 to 30, 50 to 20, and 50 to 10 in the other direction. Ranges disclosed herein, for example, “between about X and about Y” are, unless specified otherwise, inclusive of range limits about X and about Y as well as X and Y.

The disclosed subject matter provides a solution to this problem by taking advantage of laminar flow conditions prevalent for a certain range of flow rates in a reaction channel of a given geometry and using a device that provides concentric coflow, with buffer solution at the periphery of the reaction channel and the reaction mixture at the center. In this way, only the central portion of the velocity profile can be effective in defining the reaction time.

In certain embodiments, the disclosed device can include a coflow generator. The coflow generator can be configured to receive solutions and provide the solutions to the connected tubing/channel. In non-limiting embodiments, the solutions can include a buffer solution and/or a mixture of at least two components. For example, the coflow generator can receive a buffer solution and a mixture of at least two components and provide them to a connected tubing or channel at a predetermined flow rate.

In certain embodiments, the disclosed device can include an inlet, which can be coupled to the co-flow generator. For example, the two inlets for the buffer solution can be about 200 μm in diameter, and the mixture inlet can be about 100 μm in diameter. The coflow generator can receive the buffer solution and the mixture through the inlet. In non-limiting embodiments, the co-flow generator can be connected to at least two inlets (e.g., inlet for buffer solution and inlet for mixture).

In certain embodiments, the co-flow generator can be configured to make the buffer solution and the mixture co-flow in the disclosed tubing or channel.

In certain embodiments, the buffer solution can include any buffer solution known in the art (e.g., PBS, Tris, HEPES, etc.).

In certain embodiments, the mixture can include any components that can react with each other. For example, the component can include a protein, a chemical, a microorganism, an organic material, an inorganic material, a solution, a deoxyribonucleic acid (DNA), or a ribonucleic acid (RNA) that can cause any reaction when it is in contact with another component. In non-limiting embodiments, the component can include fluorescent molecules, a buffer solution, a sample protein, a sample organism, or combinations thereof. For example, mRNA, tRNA and many factors, such as initiation factors and elongation factors, are involved in translation, so all these components can be mixed with the ribosome for capturing a short-live state during translation using this device.

In certain embodiments, the disclosed device can be configured to control the temperature. For example, the buffer can be pre-cooled or pre-heated to cause the mixture to react at the target temperature.

In certain embodiments, the disclosed device can include a channel or a tubing that can be configured for reducing the parabolic velocity distribution. The channel or the tubing can be shaped such that a target mixture can be bounded not by a wall but by a co-flowing concentric buffer. In non-limiting embodiments, the disclosed device can include a tubing that connects the coflow generator and coflow separator. In non-limiting embodiments, the tubing can be a polyimide-coated glass tubing and/or a microcapillary tubing, or Polyetheretherketone (PEEK) tubing.

In certain embodiments, the tubing can be configured to receive the mixture and the buffer solution from the flow generator and have the mixture bounded by the buffer solution without contacting the wall of the tubing. For example, the buffer solution can flow adjacent to the inner wall of the tubing, and the mixture can flow at the center of the tubing bounded by the buffer solution flowing at the periphery of the tubing. In certain embodiments, the mixture can flow in a laminar state in the tubing. For example, the buffer solution in the tubing can absorb the steepest part of the parabolic velocity distribution of the mixture.

In certain limiting embodiments, the inner radius of the tubing can range from 1 μm to about 1000 μm. In non-limiting embodiments, the outer radius of the tubing can range from 50 μm to about 2000 μm.

In certain embodiments, the tubing can be configured to cause a reaction of at least two components. For example, a mixture of at least two components can react while the mixture bounded by the buffer solution flows in the tubing without contacting an inner wall of the tubing.

In certain embodiments, the tubing can be configured to control the reaction time of the sample/component solution in the tubing. For example, the reaction time can be controlled by adjusting the volume of the tubing and/or the flow rate of the mixture and/or buffer solutions. The reaction time can range from about 100 ms to about 1000 ms. In non-limiting embodiments, the length of the tubing (e.g., with a diameter of 300 μm) can be from 100 mm to about 2000 mm.

In certain embodiments, the flow rate of the mixture and the buffer solution can be controlled by syringe pumps and the buffer and the mixture can be introduced into the coflow generator, which generates the coflow pattern in the tubing. For example, the flow rate of the mixture can range from 3 μL/s to about 6 μL/s, and the buffer solution in the tubing can range from about 3 μL/s to about 60 μL/s. In non-limiting embodiments, about 0.2 m long tubing with an internal diameter of 300 μm can provide about a 600 ms reaction time.

In certain embodiments, the buffer solution and the mixture of at least two components can have different flow rates to absorb the steepest part of the parabolic velocity distribution of the mixture flow. For example, the ratio between the flow rate of the buffer solution and the flow rate of the mixture ranges from about 1:1 to about 10:1. In non-embodiments, the ratio of the diameter of the cylindric mixture flow to the diameter of the inner channel wall can be controlled by the ratio between flow rates of buffer and mixture. For example, the higher the flow rate ratio, the thinner the mixture can flow, and the narrower the time range that can be achieved. The optimum ratio between two flow rates can be determined based on the target mixture, the buffer, and/or applications (e.g., cryo-Electron Microscopy).

In certain embodiments, the tubing/channel can be configured to separate the mixture and buffer solution without being mixed in the tubing/channel. For example, the boundary between buffer and mixture can remain well defined throughout the maximum length of the reaction channel/tubing, as the fluid flow can be in the laminar state, and the radial diffusion can be minimal.

In certain embodiments, the width of the buffer (i.e., measured from the wall to the boundary of the buffer with the mixture) can be adjusted such that it can absorb the steepest part of the parabolic velocity distribution through the interaction between buffer and mixture flow. In non-limiting embodiments, by increasing the width of the buffer, a more accurate and narrower time range can be achieved in the center of the channel/tubing.

In certain embodiments, the disclosed device can include a co-flow separator. The co-flow separator can be configured to receive the buffer solution and the mixture from the tubing/channel and purge the buffer solution. For example, the flow separator can include at least one outlet for releasing the buffer solution.

In certain embodiments, the disclosed device can include a micro sprayer. The micro sprayer can be configured to generate droplets of the sample or the reacted components. For example, the sprayer can be a microsprayer configured to generate a three-dimensional cone plume of sprayed droplets. In non-limiting embodiments, the sprayer can include an inner tubing serving as a liquid injector and one outer tubing as a gas nozzle. For example, the inner tubing of the sprayer can be coupled to the co-flow reaction tubing and/or the flow separator. The inner tubing of the sprayer can be configured to receive the mixture after the buffer solution is purged. In some embodiments, orifices of inner and outer tubing can be aligned on the same plane to avoid dripping of the solution from the orifice when lower gas pressure is used. For example, the disclosed sprayer can generate a droplet without dripping at gas pressures down to 5 psi.

In certain embodiments, the disclosed device can include at least one gas inlet for providing gas pressure to the sprayer. The gas inlet can be connected to the sprayer, and the microsprayer can be configured to generate the droplets under a predetermined gas pressure. The predetermined gas pressure can range from about 5 psi to about 50 psi.

In certain embodiments, the disclosed device can be configured to prevent the buffer from being sprayed along with the reaction products. To prevent the dilution of the concentration of molecules, the two concentric streams can be divided immediately before the micro sprayer by a thin wall, causing the buffer to separate for recycling, and only the reaction products to be sprayed.

In certain embodiments, the disclosed compartments can comprise PDMS. In non-limiting embodiments, the device can be a chip assembly. For example, the coflow generator, the coflow separator, the tubing, the sprayer, and/or a combination thereof can be assembled on a glass slide, forming a chip assembly. In some embodiments, each compartment (e.g., coflow generator, coflow separator, tubing, sprayer, and/or a combination thereof) can be reused or replaced after disassembly. In non-limiting embodiments, the disclosed device can be developed using a three-dimensional (3D) printer.

In certain embodiments, the disclosed subject matter provides methods for reducing the parabolic velocity profile of the mixture of at least two components. The method can include providing a buffer solution and providing a mixture of at least two components. For example, the buffer solution and the mixture can be provided to the disclosed coflow generator.

In certain embodiments, the method can include flowing the buffer solution through the disclosed tube or channel. For example, the buffer solution can flow adjacent to an inner wall of the tubing/channel. In non-limiting embodiments, the method can include flowing the mixture of at least two components through the disclosed tubing/channel. For example, the mixture can be bounded by the buffer solution adjacent to the inner wall. The mixture can flow through the channel/tubing without contacting the inner wall. In non-limiting embodiments, at least two components can react in the disclosed channel/tubing, while the buffer solution can flow without any reaction or being mixed with the components. The buffer solution can reduce the parabolic velocity distribution of the mixture flow by absorbing the steepest part of the parabolic velocity distribution of the mixture. In non-limiting embodiments, the method can further include adjusting the width of the buffer solution in the channel. The width is the distance from the inner wall of the tubing to the boundary between the buffer solution and the mixture.

In certain embodiments, the method can include adjusting the flow rate of the buffer solution, the mixture, or a combination thereof. The reaction time of the mixture and the width of the buffer solution can be adjusted by varying the flow rate. In non-limiting embodiments, the method can include generating the channel/tubing using a 3D printer.

In certain embodiments, the method can include purging the buffer solution. For example, the flow streams of the buffer solution and the mixture can be divided immediately before the sprayer, causing the buffer to deviate for recycling, and only the reaction products to be sprayed or measured.

In certain embodiments, the method can include adjusting the temperature of the buffer solution, the mixture, or a combination thereof. Based on the target reaction of the components, the buffer solution, the mixture, or a combination thereof can be pre-heated or pre-cooled before being delivered to the disclosed device.

In certain embodiments, the method can include generating droplets of the mixture under a predetermined gas pressure. The predetermined gas pressure can range from about 5 psi to about 50 psi.

The disclosed subject matter can be used for various applications. For example, the disclosed microfluidic device can be used for time-resolved cryo-Electron Microscopy (cryo-EM). The disclosed microfluidic device can rapidly mix a plurality of components (e.g., solutions containing biological molecules), cause the reaction of the components in a continuous flow, and spray the resultants onto a grid. By reducing parabolic velocity distribution and reaction time, the microfluidic device allows a precise definition of various states of the resultants (e.g., for determination of kinetics) and their three-dimensional structure that requires an accurate time stamp for each molecule imaged.

### EXAMPLES

### Example 1: A Microfluidic Device for Reacting a Mixture Contained Within a Laminar Co-Flowing Concentric Buffer to Minimize the Spread of Velocity/Reaction Time

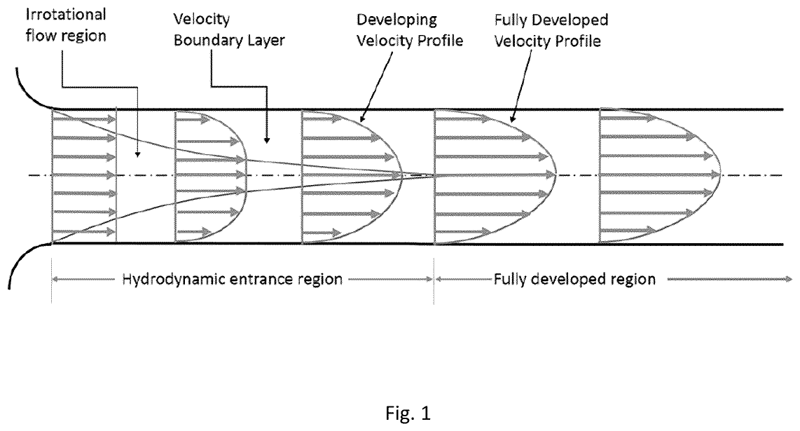

The disclosed subject matter provides a microfluidic device for reacting a mixture. In certain embodiments, the disclosed microfluidic device can be configured to reduce the parabolic velocity distribution and the reaction times of molecules during the mixing process. In certain continuous-flow or stopped-flow devices, the velocity profile is parabolic due to the radial velocity distribution. As shown in FIG. 1, when using a microcapillary tubing as the reaction channel to control the reaction time, the reaction time is not uniform because the fluid flowing inside the tubing can develop a velocity profile, i.e., the fluid in the center flows faster than that near the wall, so the residence time varies for different local regions.

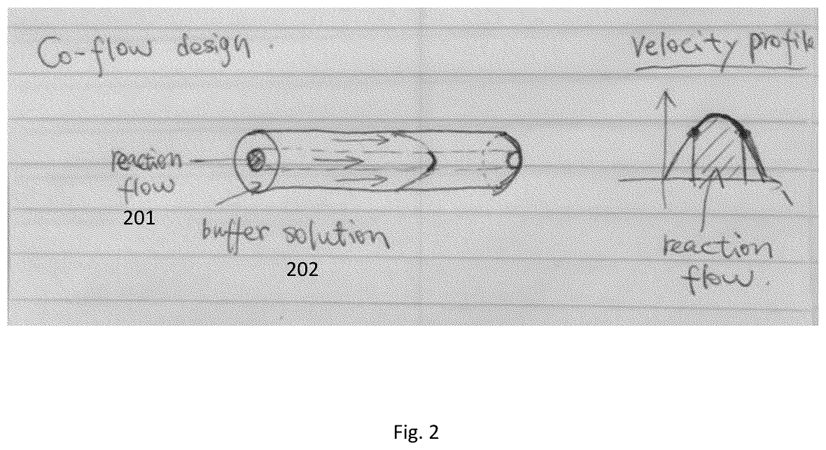

In non-limiting embodiments, the disclosed microfluidic device can be configured to introduce a concentric co-flowing buffer acting as a moving wall to reduce the parabolic velocity distribution. In certain embodiments, the disclosed microfluidic can include a channel that can be configured for reducing the parabolic velocity distribution. As shown in FIG. 2, the channel can be shaped such that a target mixture (201) can be bounded not by a wall but by a co-flowing concentric buffer (202). The width of the buffer (i.e., measured from the wall to the boundary of the buffer with the mixture) can be adjusted such that it can absorb the steepest part of the parabolic velocity distribution through the interaction between buffer and mixture flow. Consequently, a narrow time range can be achieved in the center of the channel. For the coflow pattern, the velocity profile can be expressed by a parabolic curve. The mixture takes up the middle part while the buffer solution occupies the two sides. The ratio of the width of the mixture to the buffer can be controlled by the flow rate ratio of the mixture to the buffer.

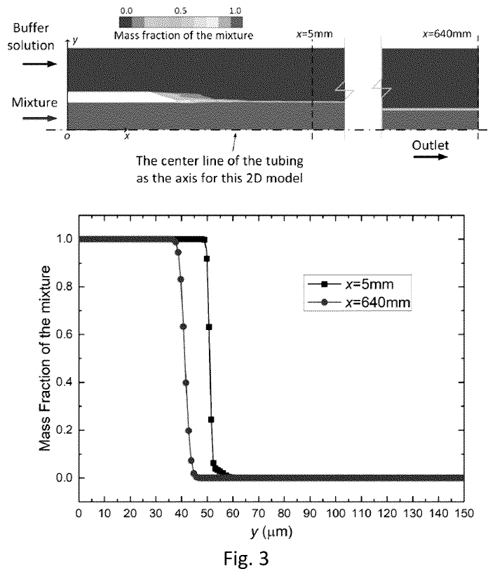

In non-limiting embodiments, the target mixture and the co-flowing concentric buffer can remain separated without being mixed in the channel. For example, the boundary between buffer and mixture can remain well defined throughout the maximum length of the reaction channel (e.g., <1 sec) because, as shown in FIG. 3, the fluid flow can be in the laminar state, and the radial diffusion can be minimal (e.g., <8 μm at the outlet of a 640 mm channel) under predetermined conditions (e.g., total flow rate ˜48 uL/s, Reynolds number ˜230).

In certain embodiments, the ratio of the diameter of the cylindric mixture flow to the diameter of the inner channel wall can be controlled by the ratio between the flow rates of the buffer and the mixture. The higher the flow rate ratio, the thinner the mixture flow, and the narrower the time range that can be achieved. For example, a ratio of 7:1 can be applied. The optimum ratio between two flow rates can be determined based on the target mixture, the buffer, and/or applications (e.g., cryo-Electron Microscopy).

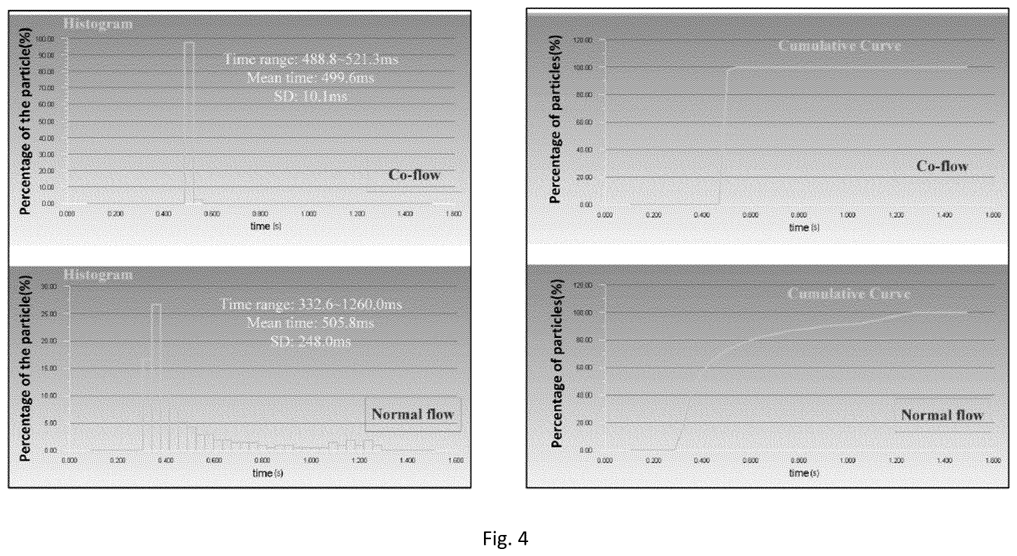

In certain embodiments, the reaction time distribution for normal flow and concentric co-flow can be numerically calculated by a two-dimensional axisymmetric simulation, where the viscous laminar model can be coupled with a discrete phase model. For example, as shown in FIG. 4, in two channels, the same flow rate was given at the inlet, and 500 ms nominal reaction time can be predefined by the volume of the channel and the mean velocity of the fluid. FIGS. 4A-4B show that the distribution changes from an unacceptable broad profile (e.g., 332.6 to 1260.0 ms) to a very sharp profile centered around 500 ms (e.g., 488.8 to 521.3 ms).

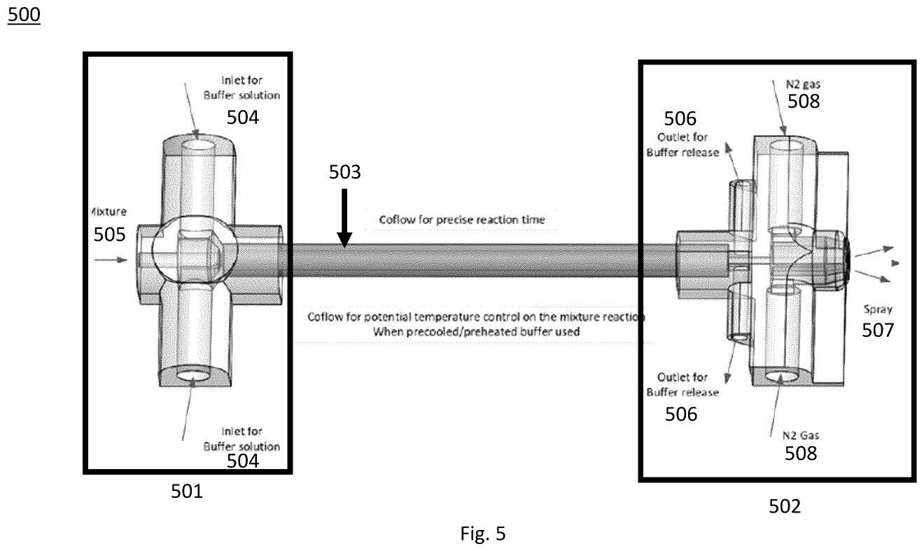

FIG. 5 shows an example device (500) for reducing the parabolic velocity profile. The example device can include a coflow generator (501) and a coflow separator (502). The coflow generator (501) can be configured to receive a buffer solution (504) and a mixture (505) of at least two components and provide them to a reaction channel/tubing (503). For example, the coflow generator (501) can include inlets for receiving buffer (504) and mixture (505). The coflow separator (502) can be configured to purge the buffer solution (506). The coflow generator (501) and the coflow separator (502) can be coupled through the tubing. The reaction channel/tubing can be configured to receive the mixture (505) and the buffer solution (504) from the flow generator (501) and flow the mixture bounded by the buffer solution without contacting a wall of the tubing. The device (500) can include a micro sprayer (507) that can generate droplets of the reacted mixture at a predetermined pressure. The pressure of the sprayer can be controlled by adjusting the pressure of N₂ gas (508) that can be injected through an inlet of the micro sprayer (507).

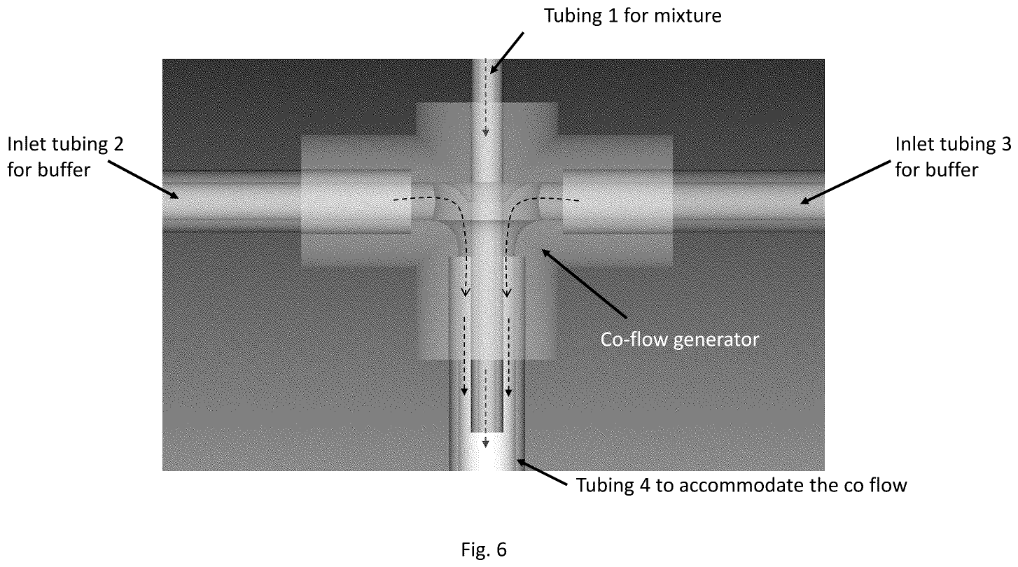

In certain embodiments, the co-flow generator can be configured to make the buffer solution and the mixture co-flow in the disclosed tubing or channel. As shown in FIG. 6, the tubing 1 is used to guide the mixture following the red arrow into the center of tubing 4. Contemporaneously, the buffer solution is introduced into the generator by tubings 2 and 3, and then the buffer solution flows along the black dashed lines to surround tubing 1. Afterward, the buffer solution can surround the mixture, which issues from tubing 4. Hence a cylindric coflow pattern can be formed. For the size of each tubing, tubing 1 is 100 μm in inner diameter (I.D.) and 170 μm in outer diameter (O.D.); I.D. 200 μm and O.D. 330 μm for tubings 2 and 3; I.D. 300 μm and O.D. 400 μm for tubing 4.

In certain embodiments, the flow rate of the mixture and the buffer solution can be controlled by syringe pumps and the buffer and the mixture can be introduced into the coflow generator, which generates the coflow pattern in the tubing 4 in FIG. 6. For example, the flow rate of the mixture can range from 3 μL/s to about 6 μL/s, and the buffer solution in the tubing can range from about 3 μL/s to about 60 μL/s. In non-limiting embodiments, about 0.2 m long tubing with an internal diameter of 300 μm can provide about a 600 ms reaction time.

In certain embodiments, the microfluidic device can be configured to prevent the buffer from being sprayed along with the reaction products. To prevent the dilution of the concentration of molecules, as shown in FIG. 5, the two concentric streams can be divided immediately before the micro sprayer by a thin wall, causing the buffer to deviate for recycling, and only the reaction products to be sprayed.

In certain embodiments, the disclosed microfluidic device can allow precise control of temperature. For example, the buffer can be pre-cooled or pre-heated to the desired temperature.

In certain embodiments, the disclosed microfluidic device can reduce protein adsorption by a channel wall. The wall of the disclosed channel can avoid direct contact with the target mixture during the reaction process, and consequently, the lifetime of the device for continuous operation or repeated operations can be extended.

The disclosed microfluidic device can be used for various applications. For example, the disclosed microfluidic device can be used for time-resolved cryo-Electron Microscopy (cryo-EM). The disclosed microfluidic device can rapidly mix a plurality of components (e.g., solutions containing biological molecules), cause the reaction of the components in a continuous flow, and spray the resultants onto an EM-grid. By reducing parabolic velocity distribution and reaction time, the microfluidic device allows a precise measurement of various states of the resultants (e.g., for determination of kinetics) and their three-dimensional structure that requires an accurate time stamp for each molecule imaged. In non-limiting embodiments, the disclosed microfluidic device can narrow a broad distribution of the reaction time of target molecules arriving at the spray nozzle by reducing the parabolic velocity distribution.

### Example 2: Fabrication of Co-Flow Device

The three-dimensional (3D) geometric models of the disclosed subject matter were developed. All the parts, including a co-flow generator (part 1), a co-flow separator, and a micro sprayer (part 2), were printed using a three-dimensional (3D) printer. The 3D printer, equipped with a 25× objective lens, worked in dip-in mode with IP-S resin transferred onto the center of a silicon wafer. IP-S is a biocompatible, non-cytotoxic photoresin. All parts were developed for 25 min in ˜25 ml of polydimethylsiloxane (PDMS) developer. Then they were cleaned by an Isopropyl alcohol (IPA) bath for 2 min and a further fresh IPA bath for 1 min. For curing any unpolymerized resin caught in the shell and scaffold, the 3D print was exposed to white light for more than 24 hrs.

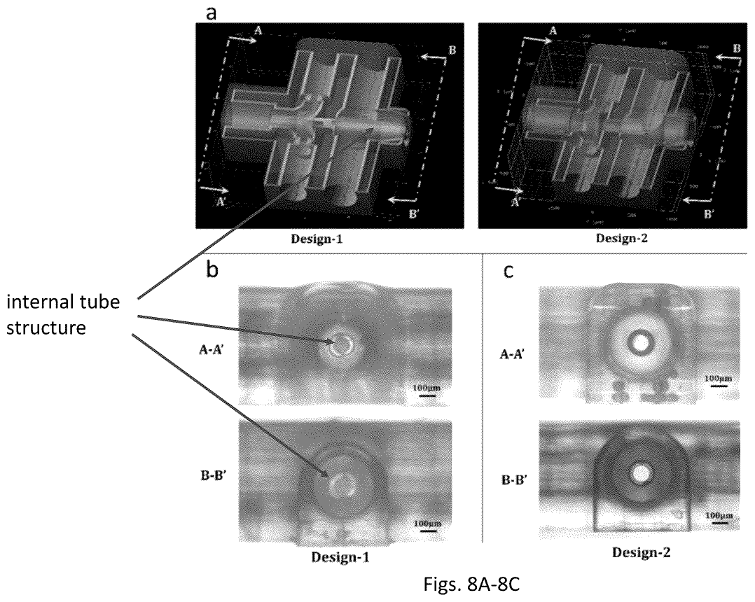

As shown in FIG. 8A, the co-flow separator and the micro sprayer can have various configurations. For example, there can be an internal tube structure for transporting the central fluid of the co-flow to the micro sprayer (FIGS. 8A and 8B, Design-1). In non-limiting embodiments, the internal tube is omitted (FIGS. 8A and 8C, Design 2). For Design 2, a capillary tubing with the same function as the internal tube in Design 1 can be inserted into the center hole. The big difference is the material; the internal structure is printed with IP-S photoresin in design 1, which is hydrophobic, while the capillary tubing in design 2 is polyimide-coated glass tubing which is hydrophilic. The latter can be desirable for the purpose of reducing the protein adsorption.

In certain embodiments, for Design 1, the walls of the internal tube can be a thickness that cannot tolerate the 3D printing development process. The thickness is from about 30 μm to about 50 μm. To assess the thickness, the orifices on both ends of the internal tube and the geometry from A-A′ and B-B′ views (FIG. 8B) can be inspected.

For Design 2, after insertion of the Polymicro-capillary tubing with the same inner diameter (I.D.) as the tube in Design 1 (I.D.=100 μm), the capillary tubing was well aligned and centered in the middle of the co-flow separator and microsprayer from A-A′ and B-B′ views (FIG. 8C). The range for I.D. of the tubing is from about 40 μm to about 200 μm. The range for O.D. of the tubing is from about 80 μm to about 280 μm.

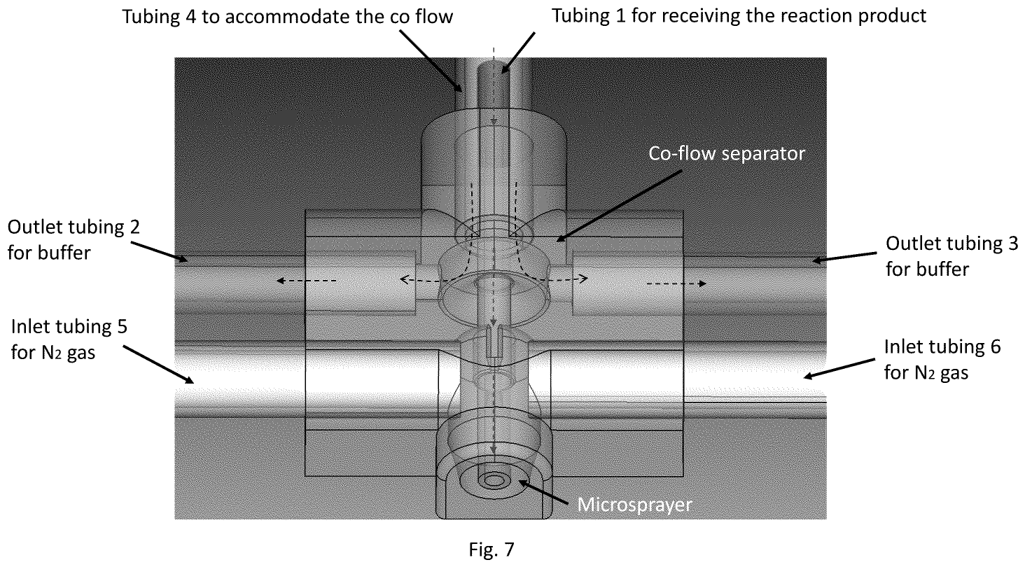

As shown in FIGS. 7 and 8, the coflow pattern can be kept by the laminar flow, so that tubing 1 can receive the reaction product in the mixture, and the buffer solution can be separated into the outlet tubings 2 and 3. Then the mixture can be sprayed out by the micro sprayer.

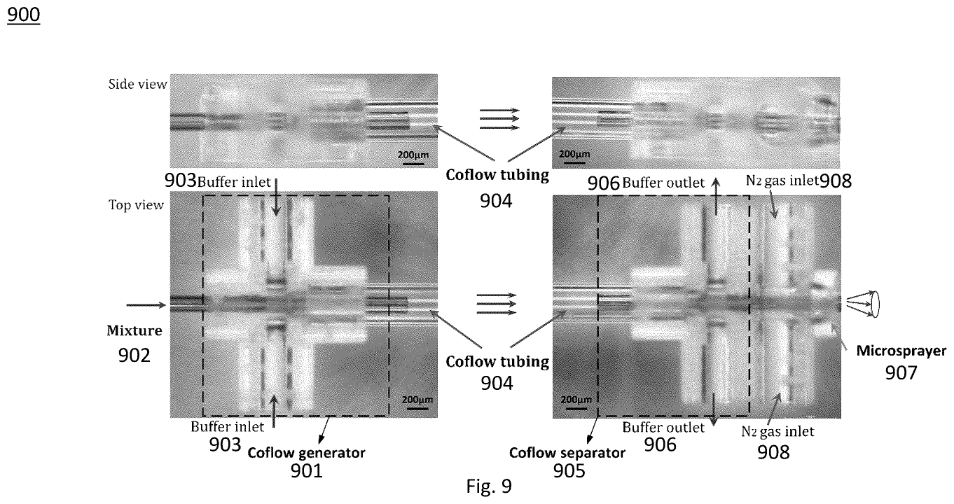

FIG. 9 shows the disclosed co-flowing chip assembly (900). In FIG. 9, on the left is part 1, called the co-flow generator (901) used to produce the co-flowing pattern. This generator receives the mixture (902) from the micromixer and buffer solutions from two inlets (903). Connected to the right end of the generator, a round quartz capillary tubing (904) was used to accommodate the co-flowing fluid. Part 2 shown on the right side of FIG. 9 includes two units: 1. Co-flow separator (905) serving to purge the buffer solution to the outlet ports (906); 2. Microsprayer (907) serving to receive and spray out reaction product onto the EM-grid under the action of pressurized N₂ gas (908). From the side and top views, the inner and outer transparent co-flow tubings are well aligned, which can ensure that the inner reaction flow can be safely (without spill) guided into the micro sprayer. After each tubing was inserted into the proper port, a drop of glue of 5-min Loctite® Epoxy was applied in place.

### Example 3: Reduction of Parabolic Velocity Profile in a Microcapillary Tubing

When using a microcapillary tubing as the reaction channel to control the reaction time, the reaction time is not uniform because the fluid flowing inside the tubing develops a velocity profile, i.e., the fluid in the center flows faster than that near the wall, so the residence time varies for different local regions.

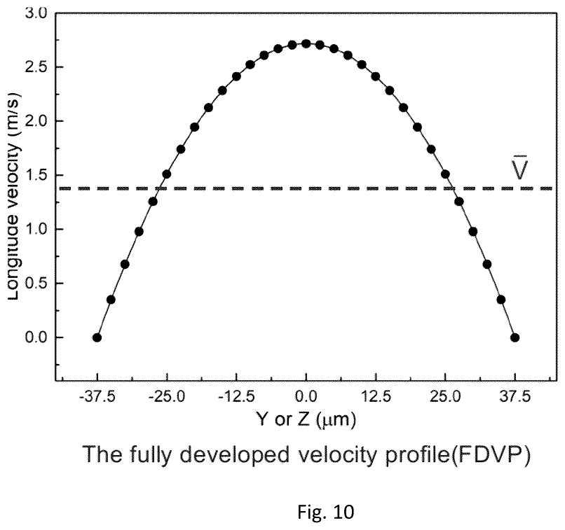

As shown in FIG. 10, the velocity profile follows this equation:

$$V ( y , z ) = 2 \overline{V} ( 1 - \frac{{( y - A )}^{2} + {( z - B )}^{λ}}{{r}^{2}} ) \qquad ( 1 )$$

where V̅ is the mean velocity (m/s), (A, B) are the coordinates of the center of the tubing, and r is the inner radius of the tubing. The hydrodynamic entrance length is calculated using the following:

$${L}_{h , Laminar} = 0.05 Re D \qquad ( 2 )$$

where Re is the Reynolds number of the fluid and D is the diameter of the tubing. When the flowrate is 6 μL/s, D=75 μm, so Re=ρV̅L/η=204, where μ and η are the density (kg/m³) and dynamic viscosity (Pa*s) of the fluid, respectively, and L is the characteristic length (m) of the tubing.

As shown in FIG. 10, the fully developed velocity profile in a pipe or a tube is parabolic. For example, if the mean velocity is 1.36 m/s, the maximum velocity is 2.72 m/s, and L_{h,Laminar}=765 μm. That means that it can take around 0.56 ms for the fluid to attain a fully developed profile.

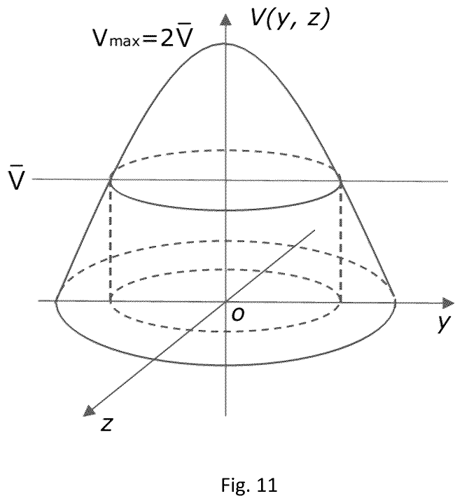

As shown in FIG. 11, based on the parabolic profile, after doing some double integrals, the volumetric flowrates in some time ranges can be obtained:

$$0 \leq V \leq \overline{V} t \geq \overline{t} {1}_{} = {{\int \int }_{V = 0}}^{\overline{V}} V ( y , z ) dydz = 25 \% {total}_{} \overline{V} < V \leq {V}_{max} 0.5 \overline{t} \leq t < \overline{t} {2}_{} = {{\int \int }_{V = \overline{V}}}^{{V}_{max}} V ( y , z ) dydz = 75 \% {total}_{} \qquad ( 3 )$$

where Vₜₒₜₐₗ is the total volumetric flowrate, V₁ and V₂ are the volumetric flowrates when the velocity satisfies 0≤V≤V̅ and V̅≤V≤Vₘₐₓ, and t̅ is the meantime.

If the following condition can be met:

$$If {3}_{} = {{\int \int }^{{V}_{max}}}_{V = x \overline{V}} V ( y , z ) dydz = 50 \% {total}_{} \qquad ( 4 )$$

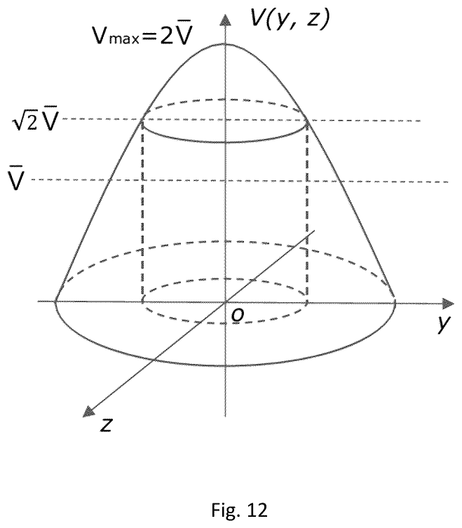

Then \sqrt{2V}<V≤Vₘₐₓ [symbol] 0.5t̅≤t<0.71t̅ can be obtained. See FIG. 12.

For example, if 600 ms (mean time) is required for a reaction, the volume of the solution reacting for a time range of 300-426 ms takes up 50% of the total volume. Therefore, it can be less accurate to get a longer time point for a reaction by increasing the tubing length than by increasing the diameter. See FIG. 12.

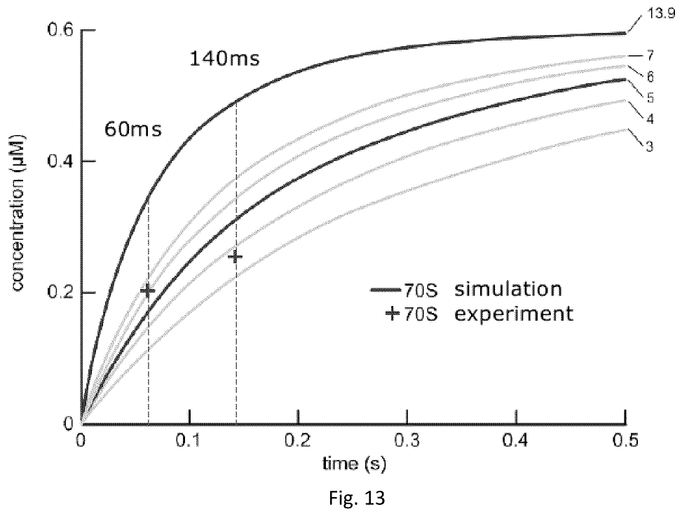

The cumulative fractions of the solution for a 600 ms reaction time point are shown in FIG. 13 and Table 1.

TABLE 1
Cumulative fractions of a solution.

| Fraction | Cutt-off time |
|---|---|
| 50% | 426 ms |
| 75% | 600 ms |
| 90% | 948 ms |

FIG. 13 and Table 1 show that the majority of the solution does not reach the designed 600 ms time point. This can be a reason why the concentration of the reacted components (e.g., 70S ribosomes) is lower than the one calculated based on the kinetics.

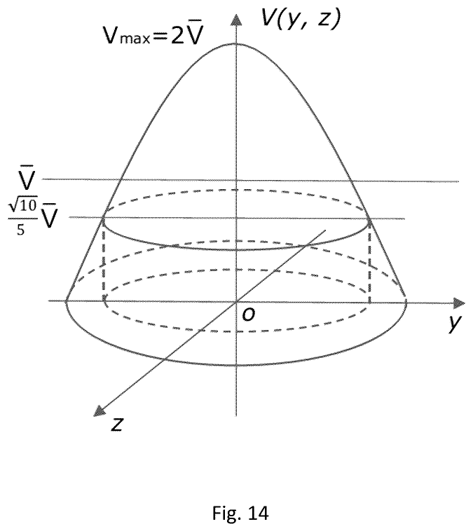

Furthermore, Table 1 shows that 90% of the total volume can react in a wide time range (e.g., between 300 ms and 948 ms), which can prevent accurate time resolution. To achieve a narrower time dispersion, the optimum solution can be the disclosed co-flow design (FIG. 14).

Unless otherwise defined, all technical and scientific terms used herein have the same meaning as commonly understood by one of ordinary skill in the art. In case of conflict, the present document, including definitions, will control. Certain methods and materials are described below, although methods and materials similar or equivalent to those described herein can be used in the practice or testing of the presently disclosed subject matter. All publications, patent applications, patents, and other references mentioned herein are incorporated by reference in their entirety. The materials, methods, and examples disclosed herein are illustrative only and not intended to be limiting.

While it will become apparent that the subject matter herein described is well calculated to achieve the benefits and advantages set forth above, the presently disclosed subject matter is not to be limited in scope by the specific embodiments described herein. It will be appreciated that the disclosed subject matter is susceptible to modification, variation, and change without departing from the spirit thereof. Those skilled in the art will recognize or be able to ascertain, using no more than routine experimentation, many equivalents to the specific embodiments described herein. Such equivalents are intended to be encompassed by the following claims.

What is claimed is:

1. A device for reducing a parabolic velocity profile, comprising:
a coflow generator configured to provide a buffer solution and a reaction mixture of at least two components to form a coflow pattern in a tubing; and
a coflow separator configured to separate the buffer solution from the reaction mixture, wherein the coflow generator and the coflow separator are coupled through the tubing, wherein the tubing is configured to receive the reaction mixture and the buffer solution from the flow generator and flow the reaction mixture bounded by the buffer solution without contacting a wall of the tubing.

2. The device of claim 1, wherein the coflow generator is configured to flow the buffer solution adjacent to the wall of the tubing.

3. The device of claim 1, wherein the reaction mixture and the buffer solution flow in a laminar state in the tubing by controlling a flow rate of the mixture or the buffer solution.

4. The device of claim 1, wherein a ratio between a flow rate of the buffer solution and a flow rate of the reaction mixture ranges from about 1:1 to about 10:1.

5. The device of claim 3, wherein the flow rate of the buffer solution ranges from 3 μL/s to about 60 μL/s, and the flow rate of the reaction mixture ranges from about 3 μL/s to about 6 μL/s.

6. The device of claim 1, wherein the buffer solution is guided to be on a periphery of the tubing and concentric to the reaction mixture.

7. The device of claim 1, wherein the device is configured to complete a reaction of the reaction mixture in a predetermined time, wherein the predetermined time is less than 1000 ms.

8. The device of claim 1, wherein the tubing comprises a capillary tubing, a three-dimensional (3D)-printed tubing, a polyether ether ketone (PEEK) tubing, a 3D-printed IP-S tubing, or a 3D IP-Q tubing.

9. The device of claim 1, wherein the coflow separator comprises an outlet for a release of the buffer solution.

10. The device of claim 1, further comprising a micro sprayer configured to generate a droplet of the reaction mixture, wherein the sprayer is coupled to the flow separator.

11. The device of claim 10, wherein the micro sprayer comprises a gas inlet for providing gas pressure.

12. The device of claim 10, wherein the tubing is aligned and centered in a center of the flow separator and the micro sprayer.

13. The device of claim 1, wherein the device is a chip assembly.

14. A method for reducing a parabolic velocity profile, comprising
providing a buffer solution to a coflow generator;
providing a reaction mixture of at least two components to the coflow generator;
flowing the buffer solution adjacent to an inner wall of a tubing;
flowing the reaction mixture bounded by the buffer solution without contacting the inner wall of the tubing; and
purging the buffer solution at the end of the tubing using a coflow separator.

15. The method of claim 14, further comprising adjusting a temperature of the buffer solution or the reaction mixture.

16. The method of claim 14, further comprising adjusting a flow rate of the buffer solution, the reaction mixture, or a combination thereof.

17. The method of claim 14, further comprising adjusting a width of the buffer solution in the tubing to absorb a steepest part of a parabolic velocity distribution of the mixture, wherein the width is a distance from the inner wall of the tubing to a boundary between the buffer solution and the reaction mixture.

18. The method of claim 14, further comprising generating a droplet of the reaction mixture at a predetermined gas pressure.

19. The method of claim 14, wherein the the coflow generator and the coflow separator are produced by a three-dimensional printer.
